(19) United States
(12) Patent Application Publication
(10) Pub. No.: US 2016/0348779 A1
(43) Pub. Date: Dec. 1, 2016

(54) CENTRIFUGAL PENDULUM AND TORQUE TRANSFER DEVICE HAVING SUCH A CENTRIFUGAL PENDULUM

(71) Applicant: SCHAEFFLER TECHNOLOGIES AG & CO. KG, Herzogenaurach (DE)

(72) Inventors: Benjamin VOEGTLE, Karlsruhe (DE); Thorsten KRAUSE, Buehl (DE)

(21) Appl. No.: 15/117,413

(22) PCT Filed: Jan. 29, 2015
(86) PCT No.: PCT/DE2015/200043

§ 371 Date: Aug. 8, 2016

(30) Foreign Application Priority Data
Feb. 12, 2014 (DE) 10 2014 202 551.6

(51) Int. Cl. F16H 45/02; F16F 15/14

(52) U.S. Cl. CPC F16H 45/02; F16F 15/145; F16H 2045/0263

(57) ABSTRACT

A centrifugal pendulum for a drivetrain of a motor vehicle, which is mounted rotatably around an axis of rotation, having a pendulum mass, a slotted guide and a pendulum flange, wherein the pendulum mass is coupled to the pendulum flange via the slotted guide, wherein the slotted guide is designed to position the pendulum mass movably in an oscillating motion along a curved oscillation path between a rest position and at least one deflected position that differs from the rest position, wherein the rest position and the deflected position have a common curvature reference point, wherein the rest position is at a first distance from the curvature reference point and the deflected position is at a second distance from the curvature reference point, wherein the first distance is different from the second distance.

The invention relates to a centrifugal pendulum and a torque transfer device.

### BACKGROUND

Centrifugal pendulums for canceling torsional vibrations are known in general from the prior art. The centrifugal pendulums have a pendulum flange, a pendulum mass and a slotted guide, where the slotted guide couples the pendulum mass with the pendulum flange. The slotted guide positions the pendulum mass movably between a deflected position and a rest position. The oscillation path is in the form of a circle arc in reference to a common curvature reference point shared by the rest position and the deflected position.

### SUMMARY OF THE INVENTION

It is an object of the present invention to provide an improved centrifugal pendulum and an improved torque transfer device having such a centrifugal pendulum.

According to the invention, it has been recognized that an improved centrifugal pendulum for a drivetrain of a motor vehicle can be provided by the centrifugal pendulum being rotatable around an axis of rotation and having a pendulum flange, a slotted guide and a pendulum mass. The pendulum mass is coupled with the pendulum flange by means of the slotted guide. The slotted guide is designed to position the pendulum mass movably in an oscillating motion along a curved oscillation path between a rest position and at least one deflected position that differs from the rest position. The rest position and the deflected position have a common curvature reference point. The rest position is at a first distance from the curvature reference point and the deflected position is at a second distance from the curvature reference point. The first distance is different from the second distance. This makes it possible to provide an elevated return force to return the pendulum mass from the deflected position to the rest position. The oscillation path can also be adapted flexibly to the torsional vibration behavior.

It is especially advantageous here if the second distance is greater than the first distance or if the second distance is smaller than the first distance.

It is also especially advantageous if the ratio of the second distance to the first distance has a value that falls within at least one of the following ranges: 0.8 to 0.99; 0.8 to 0.98; 0.8 to 0.95; 0.9 to 0.99; 0.9 to 0.98; 0.9 to 0.95; 0.95 to 0.98; 0.95 to 0.99; 1.01 to 1.2; 1.02 to 1.2; 1.05 to 1.2; 1.01 to 1.1; 1.02 to 1.1; 1.05 to 1.1; 1.01 to 1.05; 1.02 to 1.05. It has also proven to be especially advantageous for the oscillation path to be at least partially elliptical and/or parabolic and/or hyperbolic and/or according to a function of the nth order where n ε N>2. A particularly defined oscillation path can be achieved when the slotted guide in the pendulum flange has a first cutout in and with a first contour in the pendulum mass at least one second cutout with a second cutout contour. Extending through the first cutout and the second cutout is a guide element which rests against the first cutout contour and against the second cutout contour when the pendulum mass is oscillating, to determine the oscillation path.

It is also advantageous if the second distance is at least 0.1 mm greater, preferably 0.3 mm greater than the first distance, or if the second distance is at least 0.1 mm smaller, preferably 0.3 mm smaller than the first distance.

It is likewise advantageous if the oscillation path is axially symmetric or asymmetric in reference to a straight line running between the rest position and the axis of rotation.

In another embodiment the oscillation path has in a first circumferential direction a first oscillation path section with the deflected position, and in a second circumferential direction opposite the first circumferential direction a second oscillation path section with another deflected position, where the other deflected position is at a different distance from the curvature reference point, the third distance being different from the first and/or second distance. This enables an especially flexible adaptation of the oscillation path to the torsional vibration.

But the object is also fulfilled by a torque transfer device according to claim 9. Advantageous embodiments are specified in the subordinate claims.

According to the invention, it has been recognized that an improved torque transfer device for transferring torque between an input side and an output side can be provided by the torque transfer device having a first torque transfer path and a second torque transfer path, where the first torque transfer path includes a clutch that is designed to provide a torque transfer selectively between the input side and the output side, where the second torque transfer path includes a hydrodynamic converter that is designed to transfer torque between the input side and the output side, where the converter includes at least one turbine wheel, where a centrifugal pendulum is positioned on the turbine wheel and the turbine wheel is designed as described above. It is especially advantageous here if the centrifugal pendulum has a first order of matching and a second order of matching, where the first order of matching is different from the second order of matching.

### BRIEF DESCRIPTION OF THE DRAWINGS

The invention will be explained in greater detail below on the basis of figures. The figures show the following:

FIG. 1 a schematic depiction of a drive system having a torque transfer device with a centrifugal pendulum;

FIG. 2 a semi-longitudinal section through a centrifugal pendulum of the torque transfer device shown in FIG. 1;

FIG. 3 a sectional view along a sectional plane A-A shown in FIG. 2, through the centrifugal pendulum shown in FIG. 2;

FIG. 4 a schematic depiction of the centrifugal pendulum shown in FIGS. 1 through 3;

FIG. 5 a diagram of an isolation I plotted over an engine speed n for known centrifugal pendulums; and

FIG. 6 a diagram of an isolation I plotted over an engine speed n for the centrifugal pendulum shown in FIGS. 1 through 4.

### SUMMARY OF THE INVENTION

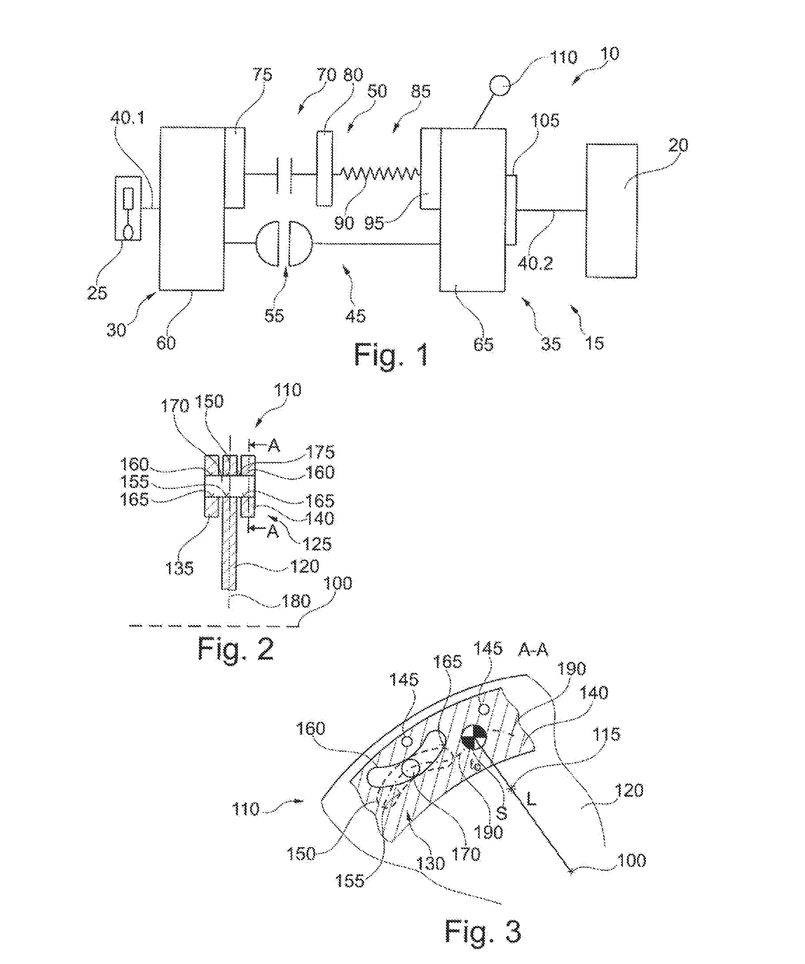

FIG. 1 shows a torque transfer device 10 for a drivetrain 15 of a motor vehicle. Let it be pointed out that in FIG. 1 rotating masses are depicted schematically as rectangular boxes. Depending on the mass, the rectangle is shown at a particular size. A rotating mass depicted as large may also be shown however for reasons of drawing, for example when a plurality of frictional connections or torques engaging with the rotating mass are provided, in order to depict them especially clearly.

FIG. 1 shows a torque transfer 40 as a broken connecting line. In FIG. 1 the torque transfer 40 shown farthest to the left is the input side 30 and the torque transfer shown farthest to the right is the output side 35. The input side 30 is set up to be connected to the reciprocating engine 25, and the output side 35 is set up to be connected to the transmission 20. The reciprocating engine 25, the torque transfer device 10 and the transmission 20 are preferably parts of the drivetrain 15 of a motor vehicle, in particular a passenger car.

Besides the torque transfer device 10, the drivetrain 15 has a transmission 20. A reciprocating engine 25 is also provided.

The torque transfer device 10 has an input side 30 and an output side 35. The torque transfer device 10 is connected torsionally on the input side 30 to the reciprocating engine 25 by means of a first torque transfer 40.1. The output side 35 is connected to the transmission 20 by means of a second torque transfer 40.2. The second torque transfer 40.2 may be designed, for example, as a transmission input shaft.

In the description of the power flow diagram of FIG. 1, the course of the flow of torque is described from the input side 30 to the output side 35, i.e., from left to right in FIG. 1. This operating state of the torque transfer device 10 usually represents the more frequent case by far. The reverse flow of torque, also called coasting mode, may also occur however, for example when the motor vehicle is decelerated by drag torque from the reciprocating engine. The torque transfer device 10 has a first torque transfer path 45 and a second torque transfer path 50. The first torque transfer path 45 has a hydrodynamic converter 55. The hydrodynamic converter 55 is designed to provide a transfer of torque which is producible by a hydrodynamic interaction between an impeller 60 and a turbine wheel 65 of the converter 55. In this case, a torque transferred by the converter 55 is dependent on a difference in speed of rotation between the turbine wheel 65 and the impeller 60. In this case, an increase in torque may occur due to hydrostatic effects, so that the converter 55 is operating essentially as a rotational speed reducer. When the speed of the turbine wheel 65 is adjusted to that of the impeller 60, the torque that is transferable by means of the converter 55 drops.

The second torque transfer path 50 has a clutch 70. The clutch 70 is designed to connect a torque transfer 40 selectively via the second torque transfer path 50. The clutch 70 has a clutch input part 75 and a clutch output part 80. The clutch input part 75 here is connected torsionally to the impeller 60 of the converter 55. The clutch output part 80 is connected to a spring damper 85. The clutch 70 may be designed, for example, as a dry clutch, a multiple plate clutch or a wet clutch running in an oil bath. To operate the clutch device, a hydraulically designed release unit may be provided for example. Electrical actuation or mechanical actuation of the clutch 70 is of course also conceivable.

The spring damper 85 is designed in this embodiment with a compression spring 90. It is of course also conceivable for the spring damper 85 to have a bow spring. The spring damper 85 has a damper output part 95. The damper output part 95 is connected torsionally to the turbine wheel 65. The spring damper 90 is designed here to provide a vibration-damped transfer of torque between the clutch output part 80 and the damper output part 95.

If a bow spring should be employed instead of the compression spring 90, then the bow spring serves as an elastic element for transmitting power, which is situated to run tangentially around an axis of rotation 100. The compression spring 90 has a similar function as the bow spring. Deviating from this, the compression spring 90 is usually of helical design and extends not bent but straight along a tangent on a circumference of a circular segment around the axis of rotation 100. The spring damper 85 may have one or more arrangements of compression springs 90 or bow springs. The bow springs or the compression springs 90 may be connected to each other in parallel and/or in series.

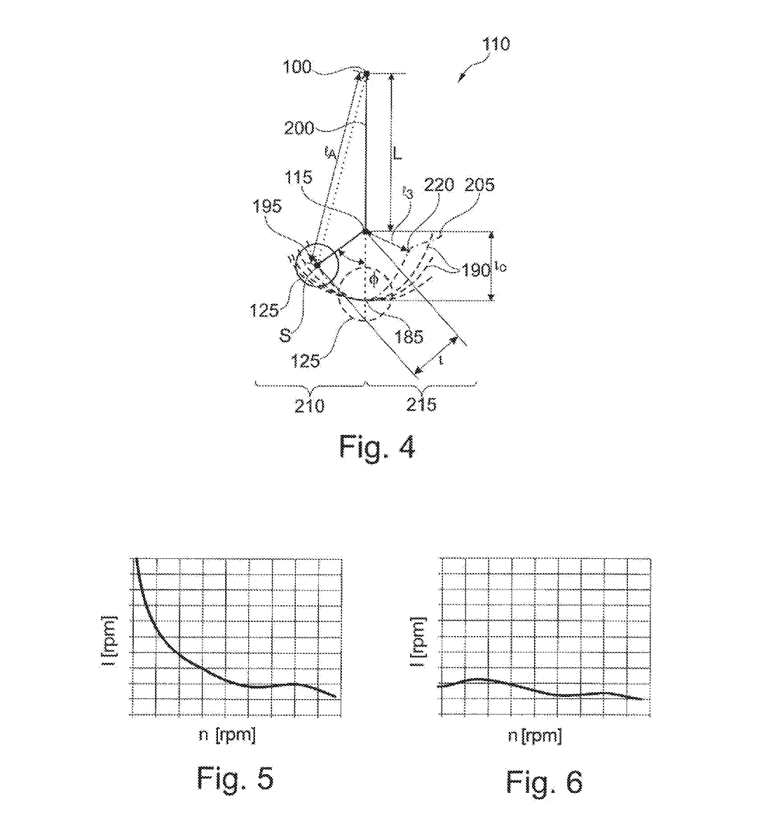

On the output side of the turbine wheel 65 an output flange 105 is provided, which provides a torsional connection to the second torque transfer 40.2 or the transmission input shaft of the transmission 20. Radially on the outside of the turbine wheel 65 a centrifugal pendulum 110 is provided. The centrifugal pendulum 110 is attached to the turbine wheel 65 in such a way that the centrifugal pendulum 110 can oscillate around a curvature reference point 115 (see FIG. 4), which is offset radially outward in relation to the axis of rotation 100 of the turbine wheel 65, the direction of rotation of the turbine wheel 65. It is of course also conceivable for the centrifugal pendulum 110 to be attached to a different rotating mass of the torque transfer device 10. At the same time, the rotating mass to which the centrifugal pendulum 110 is attached may also take on yet additional tasks, which were already explained earlier in reference to the rotating mass.

When the clutch 70 is in the disengaged state, the flow of torque takes place from the reciprocating engine 25 via the first torque transfer 40.1 into the turbine wheel 65 of the converter 55. The converter 55 transfers the torque via the first torque transfer path 45 to the turbine wheel 65. If the torque should have a torsional vibration, the centrifugal pendulum 110 is excited to oscillation, so that the centrifugal pendulum 110 at least partially cancels the torsional vibrations of the torque. The torque is transferred via the output flange 105 into the second torque transfer or the transmission input shaft 40.2, and thus is passed on to the transmission 20.

If the clutch 70 is engaged, the torque transfer 40 takes place mainly via the second torque transfer path 50. In this case, the torque transfer 40 takes place from the reciprocating engine 25 via the first torque transfer 40.1 to the impeller 60. The impeller 60 passes the torque on to the clutch input part 75. When the clutch 70 is in the engaged state, the clutch input part 75 is torsionally connected to the clutch output part 80 by means of a first frictional contact. The torque is thereby transferred from the clutch input part 75 to the clutch output part 80. The clutch output part 80 transfers the torque via the compression spring 90 to the damper output part 95. The damper output part 95 introduces the torque into the turbine wheel 65. If the torque has a torsional vibration, then the spring damper 85 has already canceled out part of the torsional vibration. Furthermore, with the remainder of the torsional vibration the centrifugal pendulum 110 positioned on the turbine 65 is excited to oscillation, so that the centrifugal pendulum 110 at least partially cancels the remaining torsional vibration. The torque, now having significantly less vibration, is transferred further via the output flange 105 into the second torque transfer 40.2, to be introduced into the transmission 20.

FIG. 2 shows a semi-longitudinal section through the centrifugal pendulum 110 shown in FIG. 1. FIG. 3 shows a detail through a sectional view along a sectional plane A-A shown in FIG. 2. FIG. 4 shows a schematic depiction of the centrifugal pendulum 110 shown in FIGS. 2 and 3. FIGS. 2 through 4 will be explained together for the purposes of improved understanding.

The centrifugal pendulum 110 has a pendulum flange 120. The pendulum flange 120 extends essentially perpendicular to the axis of rotation 100, radially from inside to outside. In FIG. 1, the pendulum flange 120 would be included in calculating the rotating mass on which the centrifugal pendulum 110 is situated. At the same time, the pendulum flange 120 should be assigned to the turbine wheel 65, for which reason the rectangular box in FIG. 1 is especially large, in order to symbolize the large proportion of mass of the turbine wheel 65 and the pendulum flange 120. Besides the pendulum flange 120, the centrifugal pendulum 110 has a pendulum mass 125. The pendulum mass 125 is coupled with the pendulum flange 120 by means of a slotted guide 130.

The pendulum mass 125 has a first pendulum mass part 135 positioned on the left side of the pendulum flange 120 and a second pendulum mass part 140 on the right side of the pendulum flange 120. The two pendulum mass parts 135, 140 are connected to each other by means of spacing bolts 145. The spacing bolt 145 reaches through the pendulum flange 120. Let it be pointed out that it is of course also conceivable for the pendulum mass 125 to have only one pendulum mass part 135, 140. To this end, the pendulum flange 120 may be designed, for example, as a dual pendulum flange, and may be situated on both sides of the pendulum mass 125. Other forms of the pendulum mass 125 are of course also possible.

In the pendulum flange 120, the slotted guide 130 has a first cutout 150, which is depicted partially dashed in FIG. 3. The first cutout 150 is kidney-shaped in this embodiment, and has a first cutout contour 155. The first cutout 150 here is curved radially inward toward the axis of rotation 100. Other forms of the first cutout 150 are of course also possible.

The slotted guide 130 also has two cutouts 160, which are located in each of the pendulum mass parts 135, 140 of the pendulum mass 125. The two cutouts 160 each have a second cutout contour 165. The second cutout 160 is likewise curved, preferably kidney-shaped; however the curvature runs radially outward.

The slotted guide 130 also has a guide element 170, which extends axially through the first and second cutouts 150, 160 in the axial direction. The guide element 170 has a circumferential side 175 which closely follows the first cutout contour 155 and the second cutout contour 165 simultaneously as the centrifugal pendulum 110 rotates.

The pendulum mass 125 also has a center of mass S. If the pendulum mass parts 135, 140 are designed symmetrically relative to a center plane 180 of the pendulum flange 120, then the center of mass S is also located in this plane. It is of course also conceivable for the pendulum mass parts 135, 140 and the slotted guide 130 to be designed asymmetrically relative to the center plane 180, so that the center of mass S lies outside the center plane 180.

If a stationary torque is transferred by means of the torque transfer device 10 shown in FIG. 1, and if at the same time the torque transfer device 10 rotates, then the pendulum mass 125 is pulled radially outward relative to the axis of rotation 100 due to the centrifugal force acting on the pendulum mass 125. Because of the geometric form of the cutouts 150, 160 with their cutout contours 155, 165, the slotted guide 130 has a rest position 185. The rest position 185 of the pendulum mass 125 is depicted schematically in FIG. 3. In this case, the rest position 185 is the position in which the pendulum mass 125 is at the greatest radial distance from the axis of rotation 100. In contrast to the deflected state, which will be described later, in the rest position 185 the pendulum mass 125 is not deflected and has no deflection angle φ. The deflection angle φ is determined between a straight line n which runs through the axis of rotation 100 and the curvature reference point 115, and a straight line which runs through the center of mass S of the pendulum mass 125 and the curvature reference point 115. In the rest position 185, the pendulum mass 125 has a first distance l₀ between the center of mass S and the curvature reference point 115.

If a torsional vibration is introduced into the centrifugal pendulum 110, the pendulum mass 125 is excited to oscillation. The sliding block guide 130 positions the pendulum mass 125 along an oscillation path 190. With conventional centrifugal pendulums, the oscillation path 190 is in the form of a circle arc, as marked in FIG. 4 by means of short dashed line segments. In this case, the shape of the oscillation path 190 is such that the pendulum mass 125 performs a movement in the circumferential direction, but at the same time is guided radially inward. With centrifugal pendulums of a known type, the curvature reference point 115 here is the center point for the oscillation path 190 in the form of a circle arc. Let it be pointed out that the described oscillation path 190 may be both a center-of-mass path of the center of mass S of the pendulum mass 125 and a guide path of the slotted guide 130. The center-of-mass path of the oscillation path 190 will be examined below on the basis of the schematic depiction in FIG. 4. The same also applies to the guide path of the slotted guide 130.

If the torsional vibration is introduced into the pendulum mass 125, the pendulum mass 125 is excited to oscillation along the oscillation path 190. Depending on the intensity of the torsional vibration, the pendulum mass 125 is deflected more severely relative to the rest position 185. The deflection is limited by the cutout contours 155, 165 of the slotted guide 130. A maximum deflection angle φ is reached when the guide element 170 hits at least one longitudinal end in the circumferential direction of the cutout contour 155, 165. In the deflected state, i.e., when the radial distance l_{A} between the center of mass S and the axis of rotation 100 is not the maximum distance L+l₀, the center of mass S is at a second distance l from the curvature reference point 115. In this embodiment, the second distance l from the deflected position 195 to the curvature reference point 115 is smaller than the first distance l₀ from the rest position 185 to the curvature reference point 115. The deflected position 195 may be the stop position, for example, but it is also conceivable for the deflected position 195 to be one of the possible positions on the oscillation path 190.

If the second distance l is smaller than the first distance l₀, when there is a movement in the circumferential direction a greater return force is provided by the pendulum mass 125 to return the pendulum mass 125 back to the rest position 185 than in the case of conventional centrifugal pendulums with circle arc oscillation paths. The result is that greater fluctuations in the torque can be canceled by the centrifugal pendulum 110. Alternatively, it is also conceivable for the second distance l to be greater than the first distance l₀, as shown in FIG. 4 with longer dashed arcs.

In this embodiment, the oscillation path 190 is elliptical. It is of course also conceivable for the oscillation path 190 to be at least partially parabolic and/or hyperbolic and/or to be shaped according to a function of the nth order at n∈N , where n≧2.

It has proven to be especially advantageous when a ratio V of the second distance l to the first distance l₀ has a value that falls within at least one of the following ranges: 0.8 to 0.99; 0.8 to 0.98; 0.8 to 0.95; 0.9 to 0.99; 0.9 to 0.98; 0.9 to 0.95; 0.95 to 0.98; 0.95 to 0.99; 1.01 to 1.2; 1.02 to 1.2; 1.05 to 1.2; 1.01 to 1.1; 1.02 to 1.1; 1.05 to 1.1; 1.01 to 1.05; 1.02 to 1.05.

It is also advantageous if the second distance l is at least 0.1 mm greater, preferably 0.3 mm greater than the first distance l₀, or if the second distance l is at least 0.1 mm smaller, preferably 0.3 mm smaller than the first distance l₀. This makes it possible to provide an especially good damping behavior, and the centrifugal pendulum 110 can be adapted flexibly to the particular torsional vibrations coming from the reciprocating engine 25.

In this embodiment, the oscillation path 190 is symmetrical, preferably axially symmetrical with respect to a plane of symmetry 200. The plane of symmetry 200 is arranged so that both the axis of rotation 100 and the curvature reference point 115 lie in the plane of symmetry 200. It is of course also conceivable for the oscillation path 190 to by asymmetrical. Furthermore, the rest position 185 also lies in the plane of symmetry 200.

In an alternative form of the slotted guide 130, the slotted guide 130 has an alternative oscillation path 205, as depicted in FIG. 4 by a dash-dotted line. The alternative oscillation path 205 is achieved by the cutout contours 155, 165 and the guide element 170 being matched to each other in such a way that the oscillation path 205 has the appropriate form. The alternative oscillation path 205 has a first section 210 to the left of a straight line that runs through the axis of rotation 100 and the rest position 185, and a second section 215 to the right of the straight line between the axis of rotation 100 and the rest position 185. The second section 215 is oriented in a second circumferential direction, opposite to a first circumferential direction in reference to the rest position 185. In the second section 215, the oscillation path 205 has additional deflected positions 220, which together form the alternative oscillation path 205. The additional deflected positions 220 are at a third distance l₃ from the curvature reference point 115. The third distance l₃ is different from the first and/or second distances 1₀,1. In this embodiment, the third distance l₃ is smaller than the first and second distances 1₀,1, so that the oscillation path 205 is steeper in the second oscillation path section 215 than in the first oscillation path section 210. This makes it possible to compensate for torsional vibrations whose path is asymmetrical. It is also conceivable to provide an optimal adaptation of the oscillation path 205 with regard to the torsional vibration of the torque by means of this design. Let it be pointed out that the oscillation paths 190, 205 shown in the figures are merely examples. Other oscillation paths 190, 205 are of course also possible.

The oscillation path 190, 205 can be used to provide centrifugal pendulums 110 in torque transfer devices 10 which have different orders of matching. In this case, a pure mass variation cannot be used as usual to design the order of matching, but rather the geometry of the oscillation path 190, 205 must be used in addition, in order to establish the order of matching of the centrifugal pendulum 110 in a defined form and adjust it to a main exciter order of the reciprocal engine 25.

FIG. 5 shows a diagram of an isolation I plotted over the engine speed n for conventional known centrifugal pendulums. FIG. 6 shows a diagram of an isolation I plotted over an engine speed n for the centrifugal pendulum 110 shown in FIGS. 1 through 4. It can be seen here that the centrifugal pendulum 110 shown in FIGS. 1 through 4 has significantly improved isolation behavior compared to conventional centrifugal pendulums, since the isolation I of the centrifugal pendulum 110 shown in FIGS. 1 through 4 (see FIG. 6) is significantly lower over the entire rotational speed range than in the case of the conventional centrifugal pendulums (see FIG. 5).

### REFERENCE LABELS

10 torque transfer device
15 drivetrain
20 transmission
25 reciprocating engine
30 input side
35 output side
40 torque transfer
45 first torque transfer path
50 second torque transfer path
55 converter
60 impeller
65 turbine wheel
70 clutch
75 clutch input part
80 clutch output part
85 spring damper
90 compression spring
95 damper output part
100 axis of rotation
105 output flange
110 centrifugal pendulum
115 curvature reference point
120 pendulum flange
125 pendulum mass
130 sliding block guide
135 first pendulum mass part
140 second pendulum mass part
145 spacing bolt
150 first cutout
155 first cutout contour
160 second cutout
165 second cutout contour
170 guide element
175 circumferential side
180 center plane
185 rest position
190 oscillation path
195 deflected position
200 plane of symmetry
205 oscillation path
210 first oscillation path section
215 second oscillation path section
220 deflected position
l second distance
l₀ first distance
l₃ third distance
S center of mass

What is claimed is:

1-10. (canceled)

11. A centrifugal pendulum for a drivetrain of a motor vehicle, the centrifugal pendulum mountable rotatably around an axis of rotation, the centrifical pendulum comprising
a pendulum flange, a slotted guide, and a pendulum mass, wherein the pendulum mass is connected to the pendulum flange via the slotted guide;
wherein the slotted guide is configured to position the pendulum mass movably in an oscillating motion along a curved oscillation path between a rest position and at least one deflected position that differs from the rest position;
wherein the rest position and the deflected position have a common curvature reference point;
wherein the rest position is at a first distance from the curvature reference point and the deflected position is at a second distance from the curvature reference point; and
wherein the first distance is different from the second distance.

12. A centrifugal pendulum according to claim 11, wherein the second distance is greater than the first distance.

13. A centrifugal pendulum according to claim 11, wherein the second distance is smaller than the first distance.

14. A centrifugal pendulum according to claim 11, wherein the ratio of the second distance to the first distance has a value that falls within at least one of the following ranges: 0.8 to 0.99; 0.8 to 0.98; 0.8 to 0.95; 0.9 to 0.99; 0.9 to 0.98; 0.9 to 0.95; 0.95 to 0.98; 0.95 to 0.99; 1.01 to 1.2; 1.02 to 1.2; 1.05 to 1.2; 1.01 to 1.1; 1.02 to 1.1; 1.05 to 1.1; 1.01 to 1.05; 1.02 to 1.05.

15. A centrifugal pendulum according to claim 11, wherein the oscillation path is at least partially elliptical and/or parabolic and/or hyperbolic and/or according to a function of the nth order where n ε N>2.

16. A centrifugal pendulum according to claim 11,
wherein the slotted guide has a first cutout with a first cutout contour in the pendulum flange, and at least one second cutout with a second cutout contour in the pendulum mass;
wherein extending through the first cutout and the second cutout is a guide element which rests against the first cutout contour and against the second cutout contour when the pendulum mass is oscillating, to determine the oscillation path.

17. A centrifugal pendulum according to claim 11, wherein the second distance is at least 0.1 mm greater than the first distance, or wherein the second distance is at least 0.1 mm smaller than the first distance.

18. A centrifugal pendulum according to claim 11, wherein the second distance is at least 0.3 mm greater than the first distance, or wherein the second distance is at least 0.3 mm smaller than the first distance.

19. A centrifugal pendulum according to claim 11, wherein the oscillation path is axially symmetric or asymmetric in reference to a plane of symmetry running between the rest position and the axis of rotation.

20. A centrifugal pendulum according to claim 11,
wherein the oscillation path has in a first circumferential direction a first oscillation path section with the deflected position, and in a second circumferential direction opposite the first circumferential direction has a second oscillation path section with another deflected position;
wherein the other deflected position is at a third distance from the curvature reference point; and
wherein the third distance is different from the first distance and/or second distance.

21. A torque transfer device for transferring torque between an input side and an output side, the torque transfer device comprising:
a centrifugal pendulum according to claim 11;
a hydrodynamic converter which is designed to transfer a torque between the input side and the output side, the hydrodynamic converter being in a first torque transfer path;
a clutch which is configured to provide a torque transfer selectively between the input side and the output side, the clutch being in a second transfer path; and
wherein the hydrodynamic converter includes at least one turbine wheel, and wherein the centrifugal pendulum is positioned on the turbine wheel.

22. A torque transfer device according to claim 21, wherein the centrifugal pendulum has a first order of matching and a second order of matching, where the first order of matching is different from the second order of matching.
